(19) United States
(12) Patent Application Publication
(10) Pub. No.: US 2026/0124625 A1
(43) Pub. Date: May 7, 2026

(54) SHOWER HEAD SPRINKLER

(71) Applicant: Xiamen Aokecheng Technology Co., Ltd, Xiamen (CN)

(72) Inventors: Shengwu ZHANG, Xiamen (CN); Jiayuan LI, Xiamen (CN)

(73) Assignee: Xiamen Aokecheng Technology Co., Ltd, Xiamen (CN)

(21) Appl. No.: 19/030,881

(22) Filed: Jan. 17, 2025

(30) Foreign Application Priority Data
Nov. 1, 2024 (CN) 2024226678335

(51) Int. Cl. B05B 1/18; B05B 1/16

(52) U.S. Cl. CPC B05B 1/18; B05B 1/1609

(57) ABSTRACT

The present application relates to the technical field of the shower device. A shower head sprinkler is provided, including a mounting housing, a water passing member, a water spray head, a shower head disc, and a water distribution member, where the water passing member is disposed in the mounting housing, one end of the water passing member is provided with a water inlet and a water inlet channel that are in communication with each other, the other end of the water passing member is provided with a water outlet and a water outlet channel that are in communication with each other, and the water spray head is located at one end of the mounting housing and is in communication with the water outlet; one side of the water passing member is provided with a first water outlet cavity.

### CROSS-REFERENCE TO RELATED APPLICATIONS

The application claims priority to Chinese patent application No. 2024226678335, filed on Nov. 1, 2024, the entire contents of which are incorporated herein by reference.

### TECHNICAL FIELD

The present application relates to the field of shower devices, and in particular, to a shower head sprinkler.

### BACKGROUND

A shower head sprinkler is a key component in a shower device, which is configured to disperse the water flow into a fine rain shape, so as to provide a comfortable shower experience.

In the related technologies, the shower head sprinkler can provide various water spray modes, such as massage, rain, mist, and the like, and these modes can be switched by rotating the sprinkler or pressing a specific button to meet different shower requirements of the user.

However, the existing shower head sprinkler usually has only one water outlet angle, which makes it difficult to meet some special shower requirements, resulting in poor usability, and therefore, the existing shower head sprinkler needs to be improved.

### SUMMARY

In order to improve the usability of a shower head sprinkler, the present application provides a shower head sprinkler.

The shower head sprinkler provided in the present application adopts the following technical solutions:
a shower head sprinkler, including a mounting housing, a water passing member, a water spray head, a shower head disc, and a water distribution member, where the water passing member is disposed in the mounting housing, one end of the water passing member is provided with a water inlet and a water inlet channel that are in communication with each other, the other end of the water passing member is provided with a water outlet and a water outlet channel that are in communication with each other, a water inlet hole that is in communication with the water inlet channel and the water outlet channel is formed in the water passing member, and the water spray head is located at one end of the mounting housing and is in communication with the water outlet; one side of the water passing member is provided with a first water outlet cavity, a first water outlet hole that is in communication with the water outlet channel and the first water outlet cavity is formed in the water passing member, the shower head disc is located on one side of the mounting housing and is in communication with the first water outlet cavity; and the water distribution member is slidably connected to the water outlet channel and is configured to block the water inlet hole, a communication hole is formed in one end of the water distribution member close to the water outlet, a first communication groove and a second communication groove are formed in a peripheral side of the water distribution member at intervals along a length direction of the water distribution member, the first communication groove is in communication with the communication hole and is configured to be in communication with the water inlet hole, and the second communication groove is configured to be in communication with the water inlet hole and the first water outlet hole simultaneously.

By adopting the above technical solution, in actual application, the water inlet hole is in communication with the first communication groove by sliding the water distribution member, and water can flow from the water inlet, the water inlet channel, the water inlet hole, the first communication groove, the communication hole, the water outlet channel, and the water outlet to the water spray head in sequence, so that the water spray head discharges the water; similarly, the second communication groove is in communication with the water inlet hole and the first water outlet hole simultaneously by sliding the water distribution member, and water can flow from the water inlet, the water inlet channel, the water inlet hole, the second communication groove, the first water outlet hole, and the first water outlet cavity to the shower head disc in sequence, so that the shower head disc discharges the water; and the water spray head is located at one end of the mounting housing, and the shower head disc is located on one side of the mounting housing, so that the shower head sprinkler has two water outlet directions to meet some special shower requirements, thereby improving the usability of the shower head sprinkler.

Preferably, the water passing member is provided with a second water outlet cavity in the first water outlet cavity, a second water outlet hole that is in communication with the water outlet channel and the second water outlet cavity is formed in the water passing member, the first water outlet hole and the second water outlet hole are disposed at intervals along a length direction of the water passing member, the shower head sprinkler further includes a blade water seat, and the blade water seat is disposed on one side of the mounting housing located on the shower head disc is in communication with the second water outlet cavity.

By adopting the above technical solution, the blade water seat is arranged, and the water distribution member is slid, so that the second communication groove is in communication with the water inlet hole and the second water outlet hole simultaneously, and water can flow from the water inlet, the water inlet channel, the water inlet hole, the second communication groove, the second water outlet hole, and the second water outlet cavity to the blade water seat in sequence, so that the blade water seat discharges the water to increase a water outlet mode of the shower head sprinkler, thereby further improving the usability of the shower head sprinkler.

Preferably, the shower head sprinkler further includes a sliding assembly, the sliding assembly includes a connecting seat and a sliding button, the connecting seat is slidably connected to the water passing member and one side of the connecting seat close to the water passing member is snap-fitted to one end of the water distribution member away from the water outlet, and the sliding button is disposed on the connecting seat and movably penetrates through the mounting housing.

By adopting the above technical solution, the connecting seat and the sliding button are arranged, and force is applied to the sliding button, so that the connecting seat drives the water distribution member to slide, so as to switch the water outlet mode of the shower head sprinkler.

Preferably, the sliding button is detachably connected to the connecting seat.

By adopting the above technical solution, the sliding button is arranged to be detachably connected to the connecting seat, so that the overall assembly of the sliding assembly is facilitated.

Preferably, a chucking groove is formed in the connecting seat, and one end of the sliding button is elastically snap-fitted to the chucking groove.

By adopting the above technical solution, the sliding button is arranged to be snap-fitted to the chucking groove, so that detachable connection between the sliding button and the connecting seat is achieved, the structure is simple, and operation is convenient.

Preferably, the sliding assembly further includes a ball and a spring, a mounting groove is formed in one side of the connecting seat close to the water passing member, the ball and the spring are disposed in the mounting groove, a plurality of limiting holes are formed in one side of the water passing member close to the connecting seat along a length direction of the water passing member, and the spring drives the ball to abut against one of the limiting holes.

By adopting the above technical solution, the ball and the spring are arranged, after the connecting seat drives the water distribution member to slide, the ball abuts against one of the limiting holes under the driving of the spring, and a user can be fed back that the shower head sprinkler is switched to another water outlet mode at the moment, so that the use experience is improved, and in addition, the water distribution member can be limited to further move, so that the use stability of the shower head sprinkler is ensured.

Preferably, the water passing member is provided with a limiting groove between the two adjacent limiting holes.

By adopting the above technical solution, the limiting groove is arranged, and the ball is limited in the limiting groove during moving, so that the stability of the switching mode of the shower head sprinkler is improved.

Preferably, a closing hole is formed in one side of the water passing member close to the connecting seat, and the closing hole and the plurality of limiting holes are located in a same straight line.

By adopting the above technical solution, the closing hole is arranged, when the spring drives the ball to abut against the closing hole, the water distribution member blocks the water inlet hole, and in this case, the shower head sprinkler does not discharge the water, so that different shower requirements can be further satisfied.

In conclusion, the present application has at least one beneficial technical effect as follows:
1. The water spray head is located at one end of the mounting housing, and the shower head disc is located on one side of the mounting housing, so that the shower head sprinkler has two water outlet directions to meet some special shower requirements, thereby improving the usability of the shower head sprinkler.
2. The blade water seat is arranged, so that the second communication groove is in communication with the water inlet hole and the second water outlet hole simultaneously by sliding the water distribution member, and water can flow from the water inlet, the water inlet channel, the water inlet hole, the second communication groove, the second water outlet hole, and the second water outlet cavity to the blade water seat in sequence, so that the blade water seat discharges the water to increase a water outlet mode of the shower head sprinkler, thereby further improving the usability of the shower head sprinkler.
3. The ball and the spring are arranged, after the connecting seat drives the water distribution member to slide, the ball abuts against one of the limiting holes under the driving of the spring, and a user can be fed back that the shower head sprinkler is switched to another water outlet mode at the moment, so that the use experience is improved, and in addition, the water distribution member can be limited to further move, so that the use stability of the shower head sprinkler is ensured.
4. The water distribution member is in a water pressure balance state in a plurality of switching states, and the water pressure of a water supply pipe does not affect a hand feeling of a push button.
5. The communication hole is disposed on an end portion of the water distribution member and is in communication with a water spray head, is integrally formed with the water distribution member, and is simple in structure and compact in layout. In a water outlet state of the water spray head, the sliding assembly is in a state of abutting against the mounting housing, and the water pressure counteraction can be resisted, so that the water outlet state of the water spray head is kept.

### BRIEF DESCRIPTION OF THE DRAWINGS

FIG. 1 is a schematic diagram of an overall structure of a shower head sprinkler according to an embodiment of the present application;

FIG. 2 is a schematic diagram of a cross-sectional structure of a shower head sprinkler according to an embodiment of the present application;

FIG. 3 is a schematic diagram of an overall structure of a water passing member according to an embodiment of the present application;

FIG. 4 is a partial exploded view of a shower head sprinkler according to an embodiment of the present application; and

FIG. 5 is a schematic enlarged view of a part A in FIG. 2.

Reference numerals: 10. mounting housing; 20. water passing member; 201. water inlet; 202. water inlet channel; 203. water outlet; 204. water outlet channel; 205. water inlet hole; 206. first water outlet cavity; 207. first water outlet hole; 208. second water outlet cavity; 209. second water outlet hole; 210. limiting hole; 211. limiting groove; 212. closing hole; 30. water spray head; 40. shower head disc; 50. water distribution member; 501. communication hole; 502. first communication groove; 503. second communication groove; 60. blade water seat; 70. sliding assembly; 71. connecting seat; 711. chucking groove; 712. mounting groove; 72. sliding button; 73. ball; 74. spring.

### DETAILED DESCRIPTION OF THE EMBODIMENTS

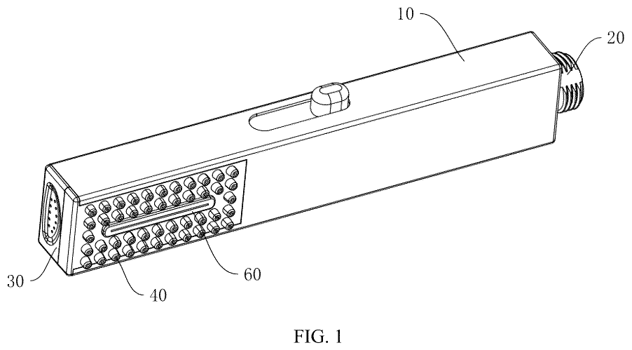

The present application will be further described in detail with reference to FIG. 1 to FIG. 5.

An embodiment of the present application discloses a shower head sprinkler.

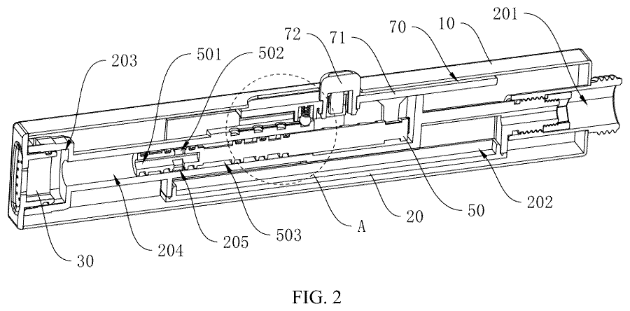

Referring to FIG. 1 and FIG. 2, the shower head sprinkler includes a mounting housing 10, a water passing member 20, a water spray head 30, a shower head disc 40, and a water distribution member 50, the mounting housing 10 is disposed in a rectangular housing shape, and the water passing member 20 is fixedly connected to the mounting housing 10. One end of the water passing member 20 is provided with a water inlet 201 and a water inlet channel 202 that are in communication with each other, the other end of the water passing member 20 is provided with a water outlet 203 and a water outlet channel 204 that are in communication with each other, and a plurality of water inlet holes 205 are formed in the water passing member 20 at intervals along a circumferential direction of the water passing member, so that the water inlet channel 202 is in communication with the water outlet channel 204. The water spray head 30 is located on one end of the mounting housing 10 and is snap-fitted to the water outlet 203, so that the water spray head 30 is in communication with the water outlet 203.

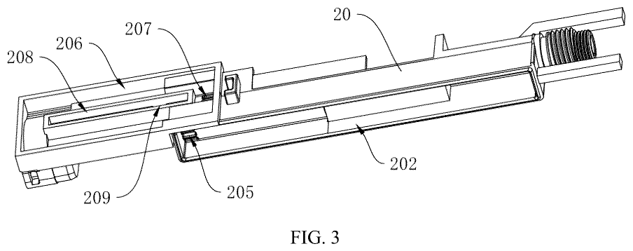

Referring to FIG. 2 and FIG. 3, in addition, one side of the water passing member 20 close to the water spray head 30 is provided with a first water outlet cavity 206, a plurality of first water outlet holes 207 in communication with the water outlet channel 204 and the first water outlet cavity 206 are formed in the water passing member 20 at intervals along the circumferential direction of the water passing member, the first water outlet hole 207 and the water inlet hole 205 are disposed at intervals along a length direction of the water passing member 20, and the shower head disc 40 is located on one side of the mounting housing 10 and is in communication with the first water outlet cavity 206.

The water distribution member 50 is slidably connected to the water outlet channel 204 along a length direction of the water outlet channel 204, so as to block the plurality of water inlet holes 205. A communication hole 501 is formed in one end of the water distribution member 50 close to the water outlet 203, a first communication groove 502 and a second communication groove 503 are formed in a peripheral side of the water distribution member 50, and the first communication groove 502 and the second communication groove 503 are disposed at intervals along a length direction of the water distribution member 50. The first communication groove 502 is in communication with the communication hole 501 and is configured to be in communication with the water inlet hole 205, and the second communication groove 503 is configured to be in communication with the water inlet hole 205 and the first water outlet hole 207 simultaneously.

In actual application, a user can slide the water distribution member 50 to enable the water inlet hole 205 to be in communication with the first communication groove 502, and water can flow from the water inlet 201, the water inlet channel 202, the water inlet hole 205, the first communication groove 502, the communication hole 501, the water outlet channel 204, and the water outlet 203 to the water spray head 30 in sequence, so that the water spray head 30 discharges the water. Similarly, the second communication groove 503 is in communication with the water inlet hole 205 and the first water outlet hole 207 simultaneously by sliding the water distribution member 50, and water can flow from the water inlet 201, the water inlet channel 202, the water inlet hole 205, the second communication groove 503, the first water outlet hole 207, and the first water outlet cavity 206 to the shower head disc 40, so that the shower head disc 40 discharges the water, that is, a water outlet mode of the shower head sprinkler can be switched by sliding the water distribution member 50. The water spray head 30 is located at one end of the mounting housing 10, and the shower head disc 40 is located on one side of the mounting housing 10, so that the shower head sprinkler has two water outlet directions to meet some special shower requirements, thereby improving the usability of the shower head sprinkler.

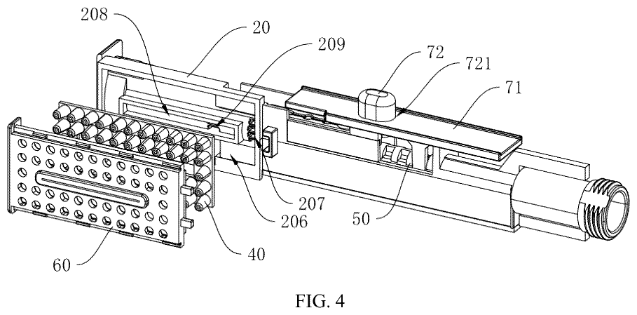

Referring to FIG. 3 and FIG. 4, in some embodiments, the first water outlet cavity 206 of the water passing member 20 is provided with a second water outlet cavity 208, a plurality of second water outlet holes 209 in communication with the water outlet channel 204 and the second water outlet cavity 208 are formed in the water passing member 20, the second water outlet hole 209 and the first water outlet hole 207 are disposed at intervals along a length direction of the water passing member 20. Meanwhile, the shower head sprinkler further includes a blade water seat 60, the blade water seat 60 is snap-fitted to one side of the mounting housing 10 located on the shower head disc 40, the shower head disc 40 is snap-fitted to the blade water seat 60 to mount the shower head disc 40, and the blade water seat 60 is in communication with the second water outlet cavity 208. Therefore, the second communication groove 503 is in communication with the water inlet hole 205 and the second water outlet hole 209 simultaneously by sliding the water distribution member 50, and water can flow from the water inlet 201, the water inlet channel 202, the water inlet hole 205, the second communication groove 503, the second water outlet hole 209, and the second water outlet cavity 208 to the blade water seat 60 in sequence, so that the blade water seat 60 discharges the water to increase a water outlet mode of the shower head sprinkler, thereby further improving the usability of the shower head sprinkler.

Referring to FIG. 2 and FIG. 4, in some embodiments, the shower head sprinkler further includes a sliding assembly 70, the sliding assembly 70 includes a connecting seat 71 and a sliding button 72, the connecting seat 71 is connected to the water passing member 20 along a length direction of the mounting housing 10, and one side of the connecting seat 71 close to the water passing member 20 is snap-fitted to one end of the water distribution member 50 away from the water outlet 203, so as to drive the water distribution member 50 to slide. The sliding button 72 is mounted on the connecting seat 71 and protrudes from the mounting housing 10, and in addition, the sliding button 72 movably penetrates through the mounting housing 10. Force is applied to the sliding button 72, so that the water distribution member 50 can be driven to slide, thereby facilitating the switching of the water outlet mode of the shower head sprinkler.

In some embodiments, the sliding button 72 is detachably connected to the connecting seat 71, and when the sliding assembly 70 is assembled, firstly, the connecting seat 71 is slidably connected to the water passing member 20, then the connecting seat 71 is snap-fitted to the water distribution member 50, and the connecting seat 71 is plugged into the mounting housing 10 through the water passing member 20, and then the sliding button 72 is mounted on the connecting seat 71, so that the overall assembly of the sliding assembly 70 is facilitated.

In some embodiments, a chucking groove 711 is formed in the connecting seat 71, and one end of the sliding button 72 close to the water passing member 20 is elastically connected to the chucking groove 711, so that detachable connection between the sliding button 72 and the connecting seat 71 is achieved, the structure is simple, and operation is convenient.

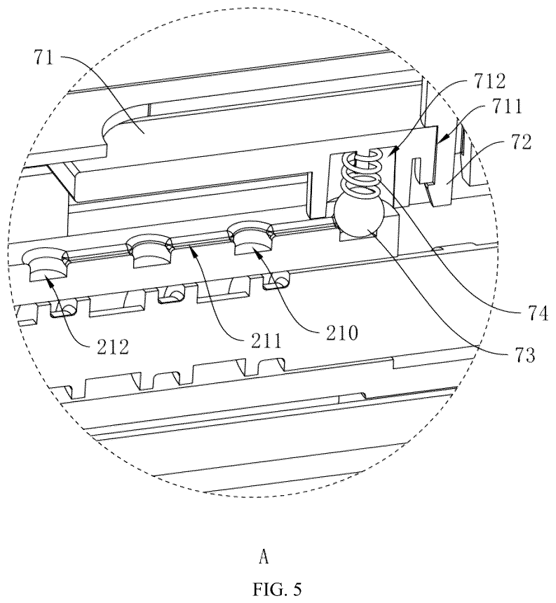

Referring to FIG. 2 and FIG. 5, in some embodiments, the sliding assembly 70 further includes a ball 73 and a spring 74, a mounting groove 712 is formed in one side of the connecting seat 71 close to the water passing member 20, the ball 73 and the spring 74 are located in the mounting groove 712, one end of the spring 74 is fixedly connected to the ball 73, and the other end of the spring is fixedly connected to a bottom wall of the mounting groove 712, so as to drive the ball 73 to extend out of the mounting groove 712. Meanwhile, a plurality of limiting holes 210 are formed in one side of the water passing member 20 close to the connecting seat 71 at intervals in a length direction of the water passing member. In this embodiment, there are three limiting holes 210, and the ball 73 abuts against one of the limiting holes 210 under the driving of the spring 74.

In actual application, when the ball 73 abuts against one of the limiting holes 210, it represents that one of the water spray head 30, the shower head disc 40 and the blade water seat 60 discharges the water, and after the connecting seat 71 drives the water distribution member 50 to slide, the ball 73 abuts against one of the limiting holes 210 under the driving of the spring 74, and a user can be fed back that the shower head sprinkler is switched to another water outlet mode at the moment, so that the use experience is improved, and in addition, the water distribution member 50 can be limited to further move, so that the use stability of the shower head sprinkler is ensured.

In some embodiments, the water passing member 20 is provided with a limiting groove 211 between the two adjacent limiting holes 210. The limiting groove 211 is configured to limit the ball 73, that is, the ball 73 is limited in the limiting groove 211 during moving, so that the stability of the switching mode of the shower head sprinkler is improved.

In some embodiments, a closing hole 212 is formed in one side of the water passing member 20 close to the connecting seat 71, and the closing hole 212 and the three limiting holes 210 are located in a same straight line. By moving the connecting seat 71, when the spring 74 drives the ball 73 to abut against the closing hole 212, the water distribution member 50 blocks the water inlet hole 205, and in this case, the shower head sprinkler does not discharge the water, so that different shower requirements can be further satisfied.

The implementation principle of this embodiment is as follows: in actual application, a user can slide the water distribution member 50 to enable the water inlet hole 205 to be in communication with the first communication groove 502, and water can flow from the water inlet 201, the water inlet channel 202, the water inlet hole 205, the first communication groove 502, the communication hole 501, the water outlet channel 204, and the water outlet 203 to the water spray head 30 in sequence, so that the water spray head 30 discharges the water. Similarly, the second communication groove 503 is in communication with the water inlet hole 205 and the first water outlet hole 207 simultaneously by sliding the water distribution member 50, and water can flow from the water inlet 201, the water inlet channel 202, the water inlet hole 205, the second communication groove 503, the first water outlet hole 207, and the first water outlet cavity 206 to the shower head disc 40, so that the shower head disc 40 discharges the water, that is, a water outlet mode of the shower head sprinkler can be switched by sliding the water distribution member 50.

It should be noted that the water spray head 30 is located at one end of the mounting housing 10, and the shower head disc 40 is located on one side of the mounting housing 10, so that the shower head sprinkler can discharge the water from two different directions to meet some special shower requirements, thereby improving the usability of the shower head sprinkler.

The above are all preferred embodiments of the application and do not limit the scope of protection of the application. Therefore, any equivalent changes made based on the structure, shape, and principle of the application should be covered within the scope of protection of the application.

What is claimed is:

1. A shower head sprinkler, comprising a mounting housing (10), a water passing member (20), a water spray head (30), a shower head disc (40), and a water distribution member (50), wherein the water passing member (20) is disposed in the mounting housing (10), one end of the water passing member (20) is provided with a water inlet (201) and a water inlet channel (202) that are in communication with each other, the other end of the water passing member is provided with a water outlet (203) and a water outlet channel (204) that are in communication with each other, a water inlet hole (205) that is in communication with the water inlet channel (202) and the water outlet channel (204) is formed in the water passing member (20), and the water spray head (30) is located at one end of the mounting housing (10) and is in communication with the water outlet (203); one side of the water passing member (20) is provided with a first water outlet cavity (206), a first water outlet hole (207) that is in communication with the water outlet channel (204) and the first water outlet cavity (206) is formed in the water passing member (20), the shower head disc (40) is located on one side of the mounting housing (10) and is in communication with the first water outlet cavity (206); and the water distribution member (50) is slidably connected to the water outlet channel (204) and is configured to block the water inlet hole (205), a communication hole (501) is formed in one end of the water distribution member (50) close to the water outlet (203), a first communication groove (502) and a second communication groove (503) are formed in a peripheral side of the water distribution member (50) at intervals along a length direction of the water distribution member, the first communication groove (502) is in communication with the communication hole (501) and is configured to be in communication with the water inlet hole (205), and the second communication groove (503) is configured to be in communication with the water inlet hole (205) and the first water outlet hole (207) simultaneously.

2. The shower head sprinkler according to claim 1, wherein the water passing member (20) is provided with a second water outlet cavity (208) in the first water outlet cavity (206), a second water outlet hole (209) that is in communication with the water outlet channel (204) and the second water outlet cavity (208) is formed in the water passing member (20), the first water outlet hole (207) and the second water outlet hole (209) are disposed at intervals along a length direction of the water passing member (20), the shower head sprinkler further comprises a blade water seat (60), and the blade water seat (60) is disposed on one side of the mounting housing (10) located on the shower head disc (40) is in communication with the second water outlet cavity (208).

3. The shower head sprinkler according to claim 1, wherein the shower head sprinkler further comprises a sliding assembly (70), the sliding assembly (70) comprises a connecting seat (71) and a sliding button (72), the connecting seat (71) is slidably connected to the water passing member (20) and one side of the connecting seat close to the water passing member (20) is snap-fitted to one end of the water distribution member (50) away from the water outlet (203), and the sliding button (72) is disposed on the connecting seat (71) and movably penetrates through the mounting housing (10).

4. The shower head sprinkler according to claim 3, wherein the sliding button (72) is detachably connected to the connecting seat (71).

5. The shower head sprinkler according to claim 4, wherein a chucking groove (711) is formed in the connecting seat (71), and one end of the sliding button (72) is elastically snap-fitted to the chucking groove (711).

6. The shower head sprinkler according to claim 3, wherein the sliding assembly (70) further comprises a ball (73) and a spring (74), a mounting groove (712) is form in one side of the connecting seat (71) close to the water passing member (20), the ball (73) and the spring (74) are disposed in the mounting groove (712), a plurality of limiting holes (210) are formed in one side of the water passing member (20) close to the connecting seat (71) along a length direction of the water passing member, and the spring (74) drives the ball (73) to abut against one of the limiting holes (210).

7. The shower head sprinkler according to claim 6, wherein the water passing member (20) is provided with a limiting groove (211) between the two adjacent limiting holes (210).

8. The shower head sprinkler according to claim 6, wherein a closing hole (212) is formed in one side of the water passing member (20) close to the connecting seat (71), and the closing hole (212) and the plurality of limiting holes (210) are located in a same straight line.
